(19) United States
(12) Patent Application Publication
(10) Pub. No.: US 2019/0320008 A1
(43) Pub. Date: Oct. 17, 2019

(54) DATA TRANSFER SYSTEM AND METHOD THEREOF

(71) Applicant: QBIC TECHNOLOGY CO., LTD., New Taipei City (TW)

(72) Inventors: Yi-Hsin CHEN, New Taipei City (TW); Ruyi LI, New Taipei City (TW); Shu-Wei CHOU, New Taipei City (TW); Juo-Yuan YANG, New Taipei City (TW)

(73) Assignee: QBIC TECHNOLOGY CO., LTD., New Taipei City (TW)

(21) Appl. No.: 15/953,938

(22) Filed: Apr. 16, 2018

(51) Int. Cl. H04L 29/08; G06F 17/30; H04L 9/06

(52) U.S. Cl. CPC H04L 67/06; G06F 17/30097; G06F 17/30156; H04L 9/0643; G06F 17/30076

(57) ABSTRACT

The present disclosure relates to a data transfer method. First, a transmitting index of a file is generated on a data transmitting device using a transmitting data block and a size of the file. The transmitting index is then transmitted to a data receiving device. The data receiving device confirms if the transmitting index matches with one of a plurality of receiving indexes stored in the data receiving device. The plurality of receiving indexes respectively represents a plurality of receiving files stored on the data receiving device. The file is transferred from the data transmitting device to the data receiving device when the transmitting index matches none of the plurality of receiving indexes. The file is not transferred when the transmitting index matches one of the plurality of receiving indexes.

### FIELD

This disclosure relates to a data transfer system and method thereof, particularly to a data transfer system capable of reducing the process time of the index for checking file transfer redundancy.

### BACKGROUND

Conventionally, file transfer between devices requires a supplementary checking mechanism for preventing redundant file transfer. Without such checking mechanism, an amount of data transfer will grow exponentially and soon be limited by transmission bandwidth.

FIG. 1 introduces a conventional way of transferring a file between devices. A file transfer system 100 includes a file transmitting device 110 and a file receiving device 160. A primary purpose of the file transfer system 100 is to decide whether a file 102 will be transferred from the file transmitting device 110 to the file receiving device 160 via a network. The file transmitting device 110 and the file receiving device 160 also share a common protocol to respectively generate a unique index of the file 102 for file redundancy checking. In addition, each of the file transmitting device 110 and the file receiving device 160 keeps a lookup table that stores a plurality of unique indexes. The plurality of unique indexes for each file are respectively stored in the file transmitting device 110 and the file receiving device 160 for reference.

In deciding whether the file transmitting device 110 will transfer the file 102, the file transmitting device 110 generates an index 104 using whole contents of the file 102. The file transmitting device 110 also forwards the index 104 to the file receiving device 160.

If the file 102 has been previously stored in the file receiving device 160, the file receiving device 160 will find a match with the index 106 in its lookup table. The file receiving device 160 then respond the file transmitting device 110 with the match, such that the file transmitting device 110 will not transfer the file 102 accordingly. In this way, file redundancy in the file receiving device 160 is avoided.

If the file 102 is not previously stored in the file receiving device 160, the file receiving device 160 will not find a match with the index 106 in its lookup table. The file receiving device 160 will respond the file transmitting device 110 with non-existence of the match, such that the file transmitting device 110 will transfer the file 102 to the file receiving device 160 in response. After the file receiving device 160 receives the file 102 via the network, the file receiving device 160 then generates an index 106 using whole contents of the received file 102 based on the abovementioned common protocol. In this way, the indexes 104 and 106 should share same contents. The file receiving device 160 then compares the index 106 with the plurality of indexes stored in its lookup table.

Such checking mechanism works well if the file 102 is of a small size. Nevertheless, if the size of the file 102 is significantly larger, e.g., of hundreds of Giga-bytes or of sizes of multimedia files or multimedia streams, it may take significant calculation time for both the file transmitting device 110 and the file receiving device 160 to generate respective indexes. If files of such size are required to be transferred frequently, e.g., as a data stream, performance and data throughput of the file transfer system 100 will be significantly reduced by increasing calculation workload of generating the indexes.

### SUMMARY

This disclosure describes a file transfer system that surpasses prior art file transfer systems in its capability of reducing processing time of determining if there is a need in transferring a file. In addition, a file transferring method applied on the described file transfer system is disclosed accordingly.

In one embodiment of the file transfer system, the file transfer system includes a data transmitting device and a data receiving device. The data transmitting device includes a transmitting storage device, a transmitting processor, and a transmitting transceiver. The transmitting storage device stores a file. The transmitting processor generates a transmitting index of the file using a transmitting data block and a size of the file. The transmitting transceiver transmits the transmitting index. The data receiving device includes a receiving data transceiver, a receiving storage device and a receiving processor. The receiving data transceiver receives the transmitting index from the transmitting transceiver. The receiving storage device stores a plurality of receiving files and a plurality of receiving indexes respectively representing the plurality of receiving files. The receiving processor confirms if the transmitting index matches one of the plurality of receving indexes, and responds with a result of confirming a match of the transmitting index to the data transmitting device via the receiving transceiver. The data transmitting device additionally transfers the file to the data receiving device via the transmitting transceiver and the receiving transceiver when the result of confirming the transmitting index indicates that the transmitting index matches none of the plurality of receiving indexes.

In one embodiment of the data transfer method, a transmitting index of a file is generated on a data transmitting device using a transmitting data block and a size of the file. A transmitting index is transmitted to a data receiving device. Whether the transmitting index matches with one of a plurality of receiving indexes stored by the data receiving device is confirmed. When the transmitting index matches none of the plurality of receiving indexes, the file is transferred from the data transmitting device to the data receiving device. The plurality of receiving indexes respectively represents a plurality of receiving files stored on the data receiving device.

### BRIEF DESCRIPTION OF THE SEVERAL VIEWS OF THE DRAWINGS

FIG. 1 introduces a conventional way of transferring a file between devices.

FIGS. 2 and 3 illustrate a data transfer system according to one embodiment of the present invention.

FIG. 4 illustrates a schematic flow chart of a file transfer method based on some embodiments of the present invention.

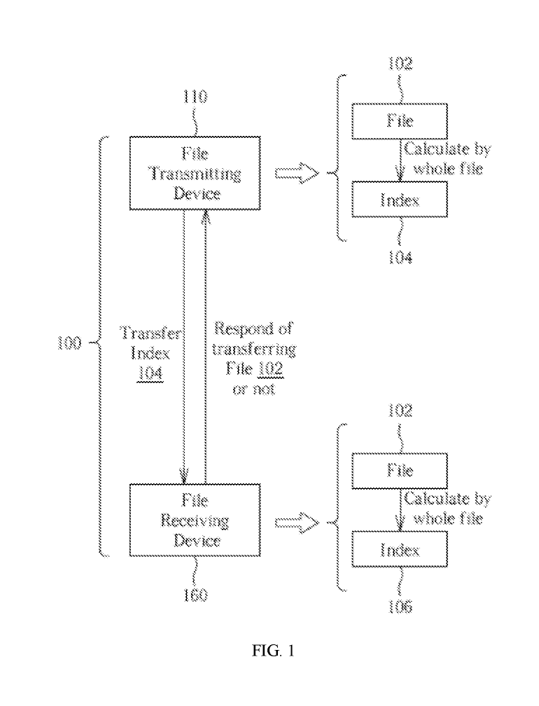

### DETAILED DESCRIPTION

For relieving the reduced performance and data throughput of conventional file transfer systems and efficiently preventing file redundancy, the present invention discloses a file transfer system that efficiently reduces the process time of the index for checking file redundancy but also enhances uniqueness of the generated index. In this way, the disclosed data transfer system is capable of rapidly confirming file redundancy, quickly deciding whether a file can be transferred, and reaching better performance and data throughput.

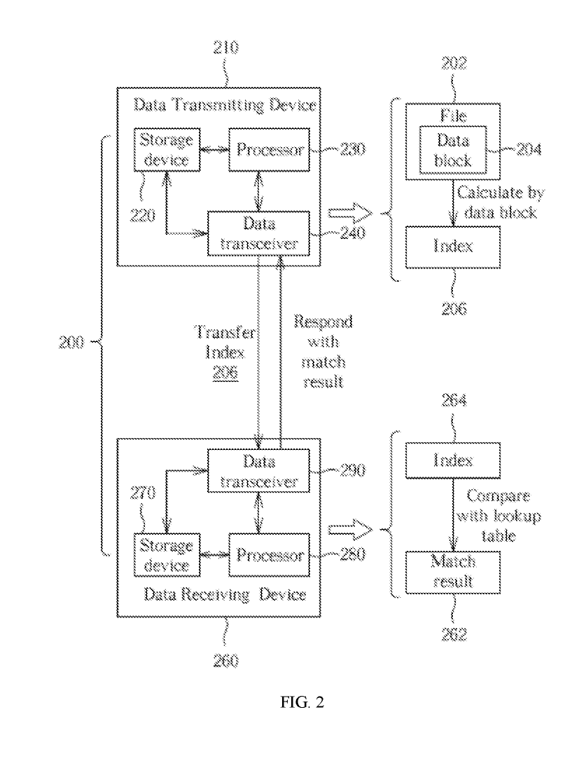

FIG. 2 illustrates a data transfer system 200 according to one embodiment of the present invention. The data transfer system 200 includes a data transmitting device 210 and a data receiving device 260. The data transmitting device 210 is capable of transferring a file 202 to the data receiving device 260. The data transmitting device 210 and the data receiving device 260 can respectively generate an index for the file 202 to confirm file redundancy in between. For convenience of following comparison of performance or benefits, the files 102 and 202 are assumed to share a same file size and same contents.

In one embodiment, the data transmitting device 210 includes a storage device 220, a processor 230 and a data transceiver 240. The data receiving device 260 includes a storage device 270, a processor 280 and a data transceiver 290. In addition, the data transmitting device 210 and the data receiving device 260 shares a common protocol for generating indexes, e.g., by handshaking in advance. In some embodiments, the data transmitting device 210 and the data receiving device 260 can exchange roles according to immediate needs of the file transfer system 200. Exemplarily, the file transfer system 200 may include multiple data transmitting devices 210 and/or multiple data receiving devices 260. Changes of numbers of the data transmitting devices 210 and the data receiving devices 260 form various embodiment of the present invention.

A mechanism of the data transfer system 200 is introduced herein. First, in the data transmitting device 210, the processor 230 fetches partial contents of the file 202 to determinea data block 204. The processor 230 then generates an index 206 by using the data block 204 with or without a size of the file 202.

In one embodiment, the data block 204 can be determined by fetching a small portion of data starting from a head of the file 202. In another embodiment, the data block 204 can be determined by fetching data starting from a tail of the file 202 with a predetermined data length. In still another embodiment, the data block 204 can be determined by fetching data starting from a specifically predetermined location of the file 202 with a predetermined data length. Exemplarily, the data block 204 may also be determined by fetching a header of the file 202. In embodiments of the present invention, how the data block 204 is fetched is communicated and shared between each device of the file transfer system 200 in advance, such that each the device fetches consistent or same contents.

In some embodiments, the processor 230 generates the index 206 by: (1) transforming the data block 204 into a hash code; and/or (2) merging the hash code with the size of the file 202 to form the index 206, e.g. in a combination form of (hash code, file size). In this way, the calculation time of generating the index 206 is significantly shorter than that of the conventional data transfer system 100. It is because: (1) a data length of the data block 204 can be significantly shorter than that of the whole file 202, such that time consumption of processing the data block 204 to generate the index 206 is thereby obviously smaller than that of processing the whole file 102 to generate the index 104 or 106; and (2) the required bits for indicating the size of a file can also be extremely few, e.g. by less than five bits, such that time consumption of putting the bits for indicating the file size in the index is almost ignorable. Even if the conventional index 104 or 106 is generated by inputting the whole file 102 into a hash function where a conventional hash code is generated accordingly, the required time consumption of generating the conventional hash code will still be much more than that of generating the hash code in the index 206 because of the size difference between the whole file 102 and the data block 204. The abovementioned reduced time consumption of the present invention will be more obvious when transferring larger and more files in the data transfer system 200 .

After the processor 230 generates the index 206, the index 206 can be stored in a lookup table kept by the storage device 220. The storage device 220 also stores the file 202 for future management. The processor 230 then forwards the index 206 to the file receiving device 260 via the transceivers 240 and 290 and a network in between. The processor 280 uses the received index 206 to compare with a plurality of indexes kept in, e.g., a lookup table stored in the storage device 270. The plurality of indexes in the storage device 270 represent a plurality of corresponding files stored in the storage device 270 respectively. In this way, a result of comparison will indicate if there is a match with the received index 206.

If a match occurs, it indicates that the file 202 has been previously stored in the storage device 270, such that there is no need to redundantly transfer the file 202 from the data transmitting device 210 to the data receiving device 260. The processor 280 then responds a match result for requesting the data transmitting device 210 not to transmit the file 202. In this way, the data transmitting device 210 will not transfer the file 202 to avoid file redundancy.

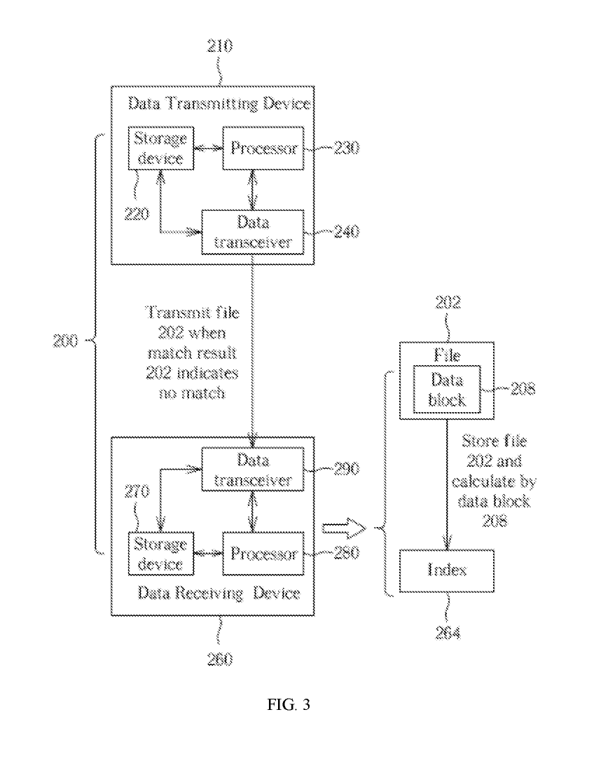

If there is no match, it indicates that the file 202 was not previously stored in the storage device 270. As such, the processor 280 responds a non-existence of the match result for requesting the data transmitting device 210 to transmit the file 202. As shown in FIG. 3, the processor 230 then fetches the file 202 and transmits the file 202 to the data receiving device 260 in response. In some embodiments, the file 202 can be transferred to the data receiving device 260 by segmented data blocks, i.e., data chunks. In addition, after the data receiving device 260 receives the file 202, e.g. by combining the data chunks, the processor 280 fetches a data block 208 out of the file 202, generates a receiving index 264 using the data block 208 and the size of the file 202, stores the file 202 into the storage device 270, and keeps the index 264 in the lookup table stored in the storage device 270 for reference. Particularly, the data block 208 should share a same location and same contents as that of the data block 204 in the file 202 for consistence of reference.

With the aid of the reduced data amount in generating indexes, calculation time for both the data transmitting device 210 and the data receiving device 260 is significantly reduced. In this way, performance and data throughput of the file transfer system 200 can be significantly improved in comparison to the conventional file transfer system 100, especially when large amounts and/or large-scale files are to be transferred. In addition, the combination of the data block and the size of the file can well guarantee uniqueness of the generated indexes. In some embodiments, the data block is transformed into a hash code using a hash function and then the hash code is merged with the file size to generate the index. The nature of the hash function that collision between different inputs (i.e., data blocks) barely occurred also significantly aids in uniqueness of generated indexes of different files. In this way, a one-to-one correspondence required for referencing a file in the lookup table of the storage device 220 or 270 can be well secured.

In one embodiment, the data block 204 or 208 is transformed into a hash code by using a hash function. The hash function may be the MD5 (Message-Digest Algorithm 5) function for better data reliability, more precise and efficient error checking, and variable input length (i.e., variable sizes of data block 204 or 208).

In one embodiment, the file transfer system 200 may be a multimedia broadcast system. In this way, the file transmitting device 210 may act as a multimedia broadcast server, and the file receiving device 260 may act as a multimedia displaying device that receives and displays files of multimedia contents transferred from the file transmitting device 210. The file transfer system 200 may apply a local area network (LAN) for facilitating data/file transmission between the file transmitting device 210 and the file receiving device 260. While the file transmitting device 210 repeatedly and frequently broadcasts multimedia contents, e.g., broadcasting a LIVE broadcast program, the mechanism applied by the file transfer system 200 may aid in repeatedly and rapidly generating and confirming indexes to avoid file redundancy in the file receiving device 260. Under a limited broadcast bandwidth, delay of file transmission and multimedia content displaying of the file receiving device 260 can be limited to a least degree. In this way, displaying quality of the file receiving device 260 can be well maintained.

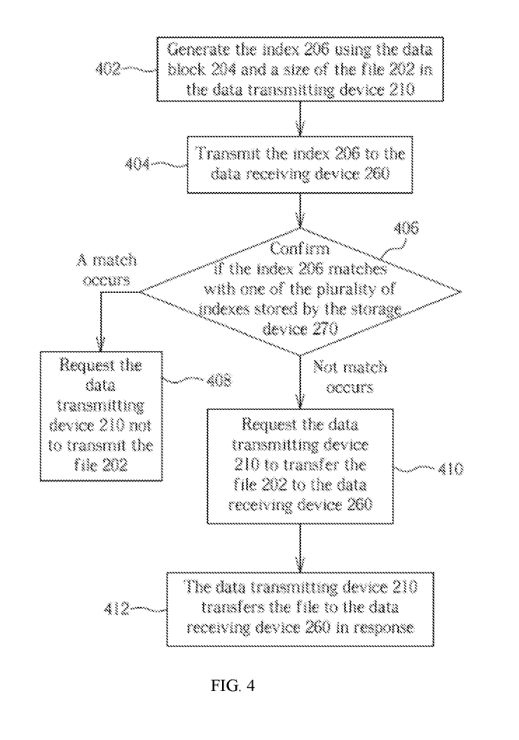

FIG. 4 illustrates a schematic flow chart of a file transfer method based on some embodiments of the present invention, e.g. primary descriptions related to FIGS. 2 and 3. The file transfer method includes the following steps:

Step 402: Generate the index 206 using the data block 204 and a size of the file 202 in the data transmitting device 210.

Step 404: Transmit the index 206 to the data receiving device 260.

Step 406: Confirm if the index 206 matches with one of the plurality of indexes stored by the storage device 270. If there is a match, go to Step 408. Else, go to Step 410.

Step 408: Request the data transmitting device 210 not to transmit the file 202.

Step 410: Request the data transmitting device 210 to transfer the file 202 to the data receiving device 260.

Step 412: The data transmitting device 210 transfers the file to the data receiving device 260 in response.

From the foregoing, it will be appreciated that specific embodiments have been described herein for purposes of illustration, but that various modifications may be made without deviating from the spirit and scope of the present technology. Moreover, aspects described in the context of particular embodiments may be combined or eliminated in other embodiments. Further, although advantages associated with certain embodiments have been described in the context of those embodiments, other embodiments may also exhibit such advantages, and not all embodiments need necessarily exhibit such advantages to fall within the scope of the present technology.

1. A data transfer method, comprising:
generating a transmitting index of a file on a data transmitting device using a transmitting data block and a size of the file;
transmitting the transmitting index to a data receiving device;
confirming if the transmitting index matches with one of a plurality of receiving indexes stored by the data receiving device; and
transferring the file from the data transmitting device to the data receiving device when the transmitting index matches none of the plurality of receiving indexes;
wherein the plurality of receiving indexes respectively represents a plurality of receiving files stored on the data receiving device.

2. The data transfer method of claim 1, wherein the step of generating the transmitting index comprises:
transforming the transmitting data block into a hash code; and
merging the hash code and the size of the file to generate the transmitting index.

3. The data transfer method of claim 1, further comprising:
fetching a file header of the file to generate the transmitting data block.

4. The data transfer method of claim 1, further comprising:
fetching data starting from a head of the file by a predetermined data length to generate the transmitting data block.

5. The data transfer method of claim 1, further comprising:
fetching data starting from a tail of the file by a predetermined data length to generate the transmitting data block.

6. The data transfer method of claim 1, further comprising:
fetching data starting from a predetermined location of the file by a predetermined data length to generate the transmitting data block.

7. The data transfer method of claim 1, further comprising:
generating a receiving index on the data receiving device using a receiving data block and the size of the file after the data receiving device receives the transferred file from the data transmitting device; and
storing the receiving index in a lookup table of the data receiving device that keeps the plurality of receiving indexes;
wherein the receiving data block shares same contents as the transmitting data block, and the receiving index shares same contents as the transmitting index.

8. The data transfer method of claim 7, further comprising:
transforming the receiving data block into a hash code; and
merging the hash code and the size of the transferred file to generate the receiving index;
wherein the plurality of receiving indexes comprise hash codes of stored files on the data receiving device.

9. The data transfer method of claim 8, further comprising:
generating the hash codes of the stored files using the MD5 (Message-Digest Algorithm 5) function.

10. The data transfer method of claim 1, further comprising:
requesting the data transmitting device not to transfer the file to the data receiving device when the transmitting index matches one of the plurality of receiving indexes.

11. A data transfer system, comprising:
a data transmitting device, comprising:
a transmitting storage device, configured to store a file;
a transmitting processor, configured to generate a transmitting index of the file using a transmitting data block and a size of the file; and
a transmitting transceiver, configured to transmit the transmitting index;
a data receiving device, comprising:
a receiving data transceiver, configured to receive the transmitting index from the transmitting transceiver;
a receiving storage device, configured to store a plurality of receiving files and a plurality of receiving indexes respectively representing the plurality of receiving files; and
a receiving processor, configured to confirm if the transmitting index matches one of the plurality of receiving indexes, and configured to respond a result of confirming a match of the transmitting index to the data transmitting device via the receiving transceiver;
wherein the data transmitting device is further configured to transfer the file to the data receiving device via the transmitting transceiver and the receiving transceiver when the result of confirming the transmitting index indicates that the transmitting index matches none of the plurality of receiving indexes.

12. The data transferring system of claim 11, wherein the transmitting processor is further configured to generate the index as a hash code.

13. The data transferring system of claim 11, wherein the transmitting processor is further configured to fetch a file header of the file to generate the transmitting data block.

14. The data transferring system of claim 11, wherein the transmitting processor is further configured to fetch the data block from a head of the file by a predetermined data length.

15. The data transferring system of claim 11, wherein the transmitting processor is further configured to fetch the data block from a tail of the file by a predetermined data length.

16. The data transferring system of claim 11, wherein the transmitting processor is further configured to fetch the transmitting data block from a predetermined location of the file by a predetermined data length.

17. The data transferring system of claim 11, wherein the receiving processor is further configured to generate a receiving index using a receiving data block and the size of the file after the data receiving device receives the file; and
wherein the receiving storage device is further configured to store the receiving index.

18. The data transferring system of claim 17, wherein the receiving processor is further configured to transform the receiving data block into a hash code, and the plurality of receiving indexes comprise hash codes of the plurality of stored files in the receiving storage device.

19. The data transfer system of claim 18, wherein the receiving processor is further configured to generate the hash codes using the MD5 (Message-Digest Algorithm 5) function.

20. The data transfer system of claim 11, wherein the receiving processor is further configured to request the data transmitting device not to transfer the file to the data receiving device when the transmitting index matches one of the plurality of receiving indexes.
